(19) United States
(12) Patent Application Publication
(10) Pub. No.: US 2004/0239763 A1
(43) Pub. Date: Dec. 2, 2004

(54) Method and apparatus for control and processing video images

(76) Inventors: Amir Notea, Raanana (IL); Ben Kirdon, Kfar Saba (IL); Isaac Carasso, Tel Aviv (IL)

Correspondence Address: WELSH & KATZ, LTD, 120 S RIVERSIDE PLAZA, 22ND FLOOR, CHICAGO, IL, 60606, US

(21) Appl. No.: 10/481,719

(22) PCT Filed: Jun. 28, 2001
(86) PCT No.: PCT/IL01/00599

(51) Int. Cl. H04N 5/225; G06K 9/00

(52) U.S. Cl. 348/169; 382/154

(57) ABSTRACT

An apparatus and method for controlling and processing of video images. The apparatus comprising a frame grabber for processing image frames received from the image-acquiring device, an Entire-View synthesis device for creating an Entire-View image from the images received, a Specified-View synthesis device for preparing and displaying a selected view from the Entire-View image, and a selection of view-point-and-angle device for receiving user input and identifying a Specified-View selected by the user. The apparatus also comprising a user interface comprising a first sub-window displaying an Entire-View image, a second sub-window displaying an Specified-View image representing an image selected by the user from the total visual information available about the action scene to be displayed as the Specified-View image.

### BACKGROUND OF THE INVENTION

1. Field of the Invention

The present invention relates to a method and apparatus for control and processing of video images, and more specifically to a user interface for receiving, manipulating, storing and transmitting video images obtained from a plurality of video cameras and a method for achieving the same.

2. Discussion of the Related Art

In recent years advances in image processing have provided the visual media such as television with the capability of bringing to the public more detailed and higher-quality images from distant locations such as images of news events, sporting events, entertainment, art and the like. Typically to record an event is to capture visually the sequences of the event. The visual sequences contain a multitude of images, which are captured and selectively transmitted for presentation to the consumers of the media such as TV viewers. The recording of the event is accomplished by suitable image acquisition equipment such as a set of video cameras. The selective transmission of the acquired images is accomplished by suitable control means such as image collection and transmission equipment. The necessary equipment associated with this operation is typically manipulated by a large crew of professional media technicians such as TV cameramen, producers, directors, assistants, coordinators and the like. In order to perform the recording of an event the image acquiring equipment such as video cameras must be set up such as to optimally cover the action, which is taking place in the action space. The cameras could be either fixed in a stationary position or could be manipulated dynamically such as being moved or rotated along their horizontal or vertical axis in order to achieve the “best shot” or to visually capture the action through the best camera angle. Such manipulation can also include changing the focus and zoom parameters of the camera lenses. Typically the cameras are located according to a predefined design that was found by past experience to be the optimal configuration for a specific event. For example, when covering an athletics competition a number of cameras are used. A 100 meter running event can be covered by two stationary cameras situated respectively at the start-line and at the finish-line of the track, a rotating (Pan) camera at a distance of about eighty meters from the start-line, a sliding camera (Dolly) that can move on a rail alongside the track, and an additional rotating (Pan) camera just behind the finish line. In a typical race, during the first eighty meters the participating runners can be shown from the front or the back by the start-line camera and the finish-line camera respectively. When the athletes approach the eighty meters mark the first rotating (Pan) camera can capture them in motion and acquire a sequence of video images shown in a rotating manner. Next, as the athletes reach the finish line a side tracking sequence of video images can be captured by the Dolly camera. At the end of the contest the second rotating (Pan) camera behind the finish line, can capture the athletes as they slow down and move away from the finish line. The set of cameras used for covering such events can be manipulated manually by an on-field operator belonging to the media crew such as a TV cameraman. An off-field operator can also control and manipulate the use of the various cameras. Other operators situated in a control center effect remote control of the cameras. In order to manipulate efficiently the cameras either locally or remotely a large and highly professional crew is required. The proficiency of the crew is crucial for obtaining broadcast-quality image sequences. The images captured by the cameras are sent to the control center for processing. The control center typically contains a variety of electronic equipment designed to scan, select, process, and transmit selectively the incoming image sequences for broadcast. The control center provides a user interface containing a plurality of display screens each displaying image sequences captured by each of the active cameras respectively. The interface also includes large control panels utilized for the remote control of the cameras, for the selection, processing, and transmission of the image sequences. A senior functionary of the media crew (typically referred to as the director) is responsible for the visual output of the system. The director continuously scans the display screens and decides at any given point in time spontaneously or according to a predefined plan the incoming image of which camera will be broadcast to the viewers. The camera view captures only a partial picture of the whole action space. These distinct views are displayed in the control center to the eyes of the director. Therefore, each display screen in isolation provides the director with only a limited view of the entire action space. Because the location of the cameras is modified during the recording of an event, the effort needed to follow the action by scanning the changing viewpoint of the distinct cameras, which all point to the action space from different angles, is disorientating. As a result when covering complex dynamic events through a plurality of cameras the director often finds it difficult to select the optimal image sequence to be transmitted. Recently, the utilization of a set of multiple cameras such as by EyeVision in combination with the use of conventional cameras has made available the option of showing an event from many different viewpoints. Sequential image broadcasting from a plurality of video cameras observing an action scene, has been revealed. In such broadcasting, images to be broadcasted are selected from each camera in each discreet time frame such that an illusionary movement is created. For example, a football game action scene can be acquired by a multiple of cameras observing such action and then broadcasted in such a manner that a certain time frame of the scene is selected from one camera, the same-time frame from the next and so on, until the a frame is taken from the last camera. If the cameras are arranged around an action scene, an illusionary feeling of a moving camera, filming around a frozen action scene is achieved. In such a system, at any given moment the number of cameras available is insufficient to cover all view points. Such situation actually means that the cameras do not cover the whole action space. Utilizing a multiple linked camera system further complicates the control task of the director due to the large number of distinct cameras to be observed during the coverage of an event. The use of a set of fixed cameras with overlapping fields of view has been suggested in order to obtain a continuous and integral field of view. In such systems multiple cameras are situated along, around and/or above of the designated action space. The camera signals representing acquired image sequences are processed by suitable electronic components that enable the reconstruction of an integrated field of view. Such systems also enable the construction of a composite image by the appropriate processing and combining of the electronically encoded image data obtained selectively from the image sequences captured by two or more cameras. However, such systems do not provide ready manipulation and control via a unified single user interface.

A typical broadcast session activated for the capture and transmission of live events such as a sport event or entertainment event includes a plurality of stationary and/or mobile cameras located such as to optimally cover the action taking place in the action space. In the control room, the director visually scans a plurality of display screens, each presenting the view of one of the plurality of cameras observing a scene. Each of said screens display a distinct and separate stream of video from the appropriate camera. The director has to select during a live transmission continuously and in real-time a specific camera the view of which will be transmitted to the viewers. To accomplish the selection of an optimal viewpoint the director must be able to conceptually visualize the entire action space by the observation of the set of display screens distributed over a large area, which show non-continuous views of the action space. The control console is a complex device containing a plurality of control switches and dials. As a result of this complexity the operation of the panel requires additional operators. Typically the selection of the camera view to be transmitted is performed by manually activating switches which select a specific camera according to the voice instructions of the director. The decision concerning which camera view is to be transmitted to the viewers is accomplished by the director while observing the multitude of the display screens. Observing and broadcasting a wide-range, dynamic scene with a large number of cameras is extremely demanding and the ability of a director to observe and select the optimal view from among a plurality of cameras is greatly reduced.

Existing computerized user interface applications handling video images use video images obtained from a single camera at a time as well as using two or more images in techniques such as dissolve or overlay to broadcast more than one image. Such systems, however, do not create new images and do not perform an extensive and precise analysis, modification, and synthesis of images from a plurality of cameras. These applications for the handling of video images allow the display of one or a series of images at a specific location but do not allow the display of a series of streaming video images from a multiple set of cameras on a continuous display window. There is a great need for an improved and enhanced system that will enable the control and processing of video images.

### SUMMARY OF THE PRESENT INVENTION

It is therefore the purpose of the present invention to propose a novel and improved method and apparatus for the control and processing of video images. The method and apparatus provide at least one display screen displaying a composite scene created by integrated viewpoints of a plurality of cameras, preferably with a shared or partially shared field of view.

Another objective of the present invention is to provide switch free, user friendly controls, enabling a director to readily capture and control streaming video images involving a wide, dynamically changing action space covered by a plurality of cameras as well as manipulating and broadcasting video images.

An additional objective of the present invention is to construct and transmit for broadcast and display video images selected from a set of live video images. Utilizing the proposed method and system will provide the director of the media crew with an improved image controlling and selection interface.

A first aspect of the present invention regards an apparatus for controlling and processing of video images, the apparatus comprising a frame grabber for processing image frames received from the image-acquiring device, an Entire-View synthesis device for creating an Entire-View image from the images received, a Specified-View synthesis device for preparing and displaying a selected view from the Entire-View image, and a selection of point-of-view and angle device for receiving user input and identifying a Specified-View selected by the user. The apparatus can further include a frame modification module for image color and geometrical correction. The apparatus can also include a frame modification module for mathematical model generation of the image, scene or partial scene. The apparatus can further include a frame modification module for image data modification. The frame grabber can further include an analog to digital converter for converting analog images to digital images.

A second aspect of the present invention regards an apparatus for controlling and processing of video images. The apparatus includes a coding and combining device for transforming information sent by an image capturing device and combining the information sent into a single frame dynamically displayed on a display. It further includes a selection and processing device for selecting and processing the viewpoint and angle selected by a user of the apparatus.

A third aspect of the present invention regards within a computerized system having at least one display, at least one central processing unit and at least one memory device, and a user interface for controlling and processing of video images. The user interface operates in conjunction with a video display and at least one input device. The user interface can include a first sub-window displaying an Entire-View image, a second sub-window displaying a Specified-View image representing an image selected by the user from the Entire-View. Also can be included is a third sub-window displaying a time counter indicating a predetermined time. The Entire-View can comprise a plurality of images received from a plurality of sources and displayed by the video display. The user interface can also include a view-point-and-angle selection device for selecting the image part selected on the Entire-View and displayed as the Specified-View image. The user interface can further include a view-point-and-angle Selection-Indicator device for identifying the image part selected on the Entire-View and displayed as the Specified-View image. The view-point-and-angle selection device can be manipulated by the user in such a way that the view-point-and-angle Selection-Indicator is moved within the Entire-View image. The Specified-View display images are typically provided by at least two images, the right hand image is directed towards the right eye and the left-hand image is directed towards the left eye. The user interface can also include operation mode indicators for indicating the operation mode of the apparatus. The user interface can also include a topology frame for displaying the physical location of at least one image-acquiring device. The user interface can also include a topology frame for displaying the physical location of at least one image-acquiring device associated with the image-acquiring device information displayed in the second sub-window displaying a Specified-View image. The user interface can further include at least one view-point-and-angle selection indicator.

A fourth aspect of the present invention regards a computerized system having at least one display, at least one central processing unit, and at least one memory device, and a method for controlling and processing of video images within a user interface. The method comprising determining a time code interval and processing the image corresponding to the time code interval, whereby the synthesis interval does not affect the processing and displaying of the image. The method can further comprise the step of setting a time code from which image is displayed. The step of processing can also include retrieving frames for all image sources from an image source for the time code interval associated with the image selected, selecting participating image sources associated with the view point and angle selected by the user, determining warping and stitching parameters, preparing images to be displayed in selection indicator view, and displaying image in the selection indicator. The step of processing can alternatively include constructing Entire-View movie from at least two images, displaying Entire-View image, determining view-point-and-angle selector position and displaying view-point-and-angle Selection-Indicator on display. It can also include constructing Entire-View image from at least two images and storing said image for later display. Or constructing Entire-View movie from at least two images and storing said image for later transmission. The step of constructing can also include obtaining the at least two image from a frame modification module and warping and stitching the at least two images to create an Entire-View image. Finally, the method can also include the steps of displaying a view-point-and-angle Selection-Indicator on an Entire-View frame and determining the specified view corresponding to a user movement of the view-point-and-angle selector on an Entire-View frame.

### BRIEF DESCRIPTION OF THE DRAWINGS

The present invention will become more understood from the detailed description of a preferred embodiment given hereinbelow and the accompanying drawings which are given by way of illustration only, wherein;

FIG. 1 is a graphic representation of the main components utilized by the method and apparatus of the present invention.

FIG. 2 is a block diagram illustrating the functional components of the preferred embodiment of the present invention.

FIG. 3 is a flow chart diagram describing the general data flow according to the preferred embodiment of the present invention.

FIG. 4 is a graphical representation of a typical graphical interface main window, displayed to a user in accordance with the preferred embodiment of the present invention.

FIG. 5 is a flow chart diagram of the user interface operational routine of the preferred embodiment of the present invention.

### DETAILED DESCRIPTION OF PREFERRED EMBODIMENTS

The present invention overcomes the disadvantages of the prior art by providing a novel method and apparatus for control and processing of video images. To facilitate a ready understanding of the present invention the retrieval, capture, transfer and likewise manipulation of video images from one or more fixed-position cameras connected to a computer system is described hereinafter with reference to its implementation. Further, references are sometimes made to features and terminology associated with a particular type of computer, camera and other physical components; It will be appreciated, however, that the principles of the invention are not limited to this particular embodiment. Rather, the invention is applicable to any type of physical components in which it is desirable to provide such a comprehensive method and apparatus for control and processing of video images. The embodiments of the present invention are directed at a method and apparatus for the control and processing of video images. The preferred embodiment is a user interface system for the purpose of viewing, manipulating, storing, transmitting and retrieving video images and the method for operating the same. Such system accesses and communicates with several components connected to a computing system such as a computer.

In the proposed system and method preferably a single display device displays a scene of a specific action space covered simultaneously by a plurality of video cameras where cameras can have a partially or fully shared field of view. In an alternative embodiment multiple display devices are used. The use of an integrated control display is proposed to replace or supplement the individual view screens currently used for the display of each distinct view provided by the respective cameras. Input from a plurality of cameras is integrated into an “Entire-View” format display where the various inputs from the different cameras are constructed to display an inclusive view of the scene of the action space. The proposed method and system provides an “Entire-View” format view that is constructed from the multiple video images each obtained by a respective camera and displayed as a continuum on a single display device in such a manner that the director managing the recording and transmission session only has to visually perceive a simplified display device which incorporates the whole scene spanning the action space. It is intended that the individual images from each camera be joined together on a display screen (or a plurality of display devices) in order to construct the view of the entire scene. An input device that enables the director to readily select, manipulate and send to transmission a portion of the general scene, replaces the currently operating plurality of manually operated control switches. A Selection-Indicator, sometimes referred to as “Selection-Indicator frame” assists in the performance of the image selection. The Selection-Indicator frame allows the user to pick and display at least one view-point received from a plurality of cameras. The Selection-Indicator is freely movable within the “Entire-View” display, using the input device. Selection-Indicator frame represents the current viewpoint and angle offered for transmission and is referred to as a “virtual camera”. Such virtual camera can allow a user to observe any point in the action scene from any point of view and from any angle of view covered by cameras covering said scene. The virtual camera can show an area which coincides with the viewing field of a particular camera, or it can consist of a part of the viewing field of a real camera or a combination of real cameras. The virtual camera view can also consist of information derived indirectly from any number of cameras and/or other devices acquiring data such as Zcam from 3DV about the action-space, as well as other view points not covered by any particular camera alone, but, covered via shared field of views of at least two any cameras. The system tracks the Selection-Indicator also referred to here as View-Point-and-Angle Selector (VPAS), and selects the video images to be transmitted. If the selected viewpoint & angle is to be derived from two cameras, then the system can automatically choose the suitable portions of the images to be synthesized. The distinct portions from the distinct images are adjusted, combined, displayed, and optionally transmitted to target device external to the system. In other embodiments, the selected viewpoint & angle are synthesized from a three-dimensional mathematical model of the action-space. Stored video images, whether Entire-View images or Specified-View images can also be constructed and sent for display and transmission.

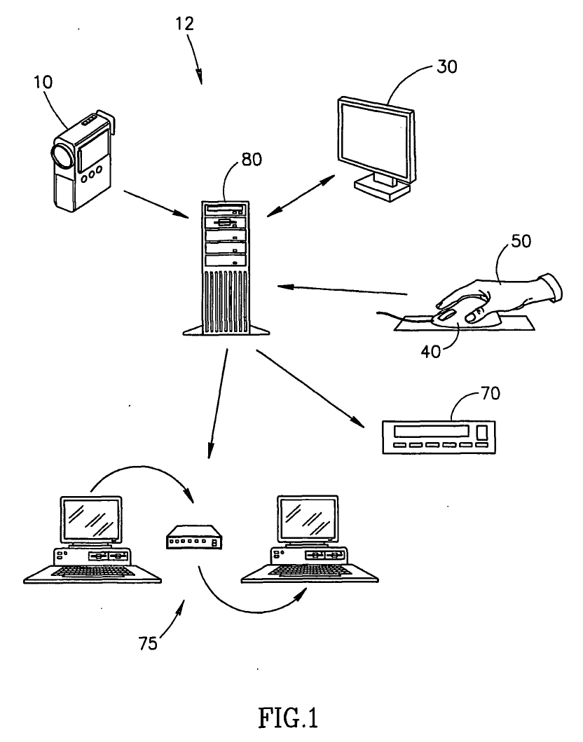

Referring now to FIG. 1, which is a graphic representation of the main components utilized by the method and apparatus of the present invention in accordance with the preferred embodiment of the present invention. The system 12 includes video image-acquiring devices 10 to capture multiple video image sequence streams, stills images and the like. Device 10 can be but not limited to digital cameras, lipstick-type cameras, super-slow motion type cameras, television camera, ZCam-type devices from 3DV Systems Ltd. and the like, or a combination of such cameras and devices. Although only a single input device 10 is shown on the associated drawing it is to be understood that in a realistically configured system a plurality of input devices 10 will be used. Device 10 is connected via communication interface devices such as coaxial cables to a programmable electronic device 80, which is designed to store, retrieve, and process electronically encoded data. Device 80 can be a computing platform such as an IBM PC computer or the like. Computing device 80 typically comprises a central processing unit, a memory storage devices, internal components such as a video and audio device cards and software, input and output devices and the like (not shown). Device 80 is operative in the coding and the combining of the video images. Device 80 is also operative in executing selection and processing requests performed on specific video streams according to requests submitted by a user 50 through the manipulation of input device 40. Computing device 80 is connected via communication interface devices such as suitable input/output devices to several peripheral devices. The peripheral devices include but are not limited to input device 40, visualization device 30, video recorder device 70, and communication device 75. Communication device 75 can be connected to other computers or to a network of computers. Input device 40 can be a keyboard, a joystick, or a pointing device, such as a trackball, a pen or a mouse. For example a Microsoft® Intellimouse® Serial pointing device or the like can be used as device 40. Input device 40 is manipulated by user 50 in order to submit requests to computing device 80 regarding the selection of specific viewpoints & angles, and the processing of the images to synthesize the selected viewpoint & angle. As a result of the processing the processed segments of video images, from the selected video images will be integrated into a single video image stream. Visualization device 30 includes the user interface, which is operative in displaying a combined video image created from the separate video streams by computing device 80. The user interface associated with device 30 is also utilized as a visual feedback to the user 50 regarding the requests of user 50 to computing device 80. Device 30 can display optionally operative controls and visual indicators graphically to assist user 50 in the interaction with the system 12. In certain embodiments, system 12 or part of it is envisioned by the inventor of the present invention to be placed in a Set Top Box (STB). In the present time STB CPU power is inadequate, thus such embodiment can be accomplished in the near future. The user interface will be described in detail hereunder in association with the following drawings. Visualization device 30 can be but not limited to a TV screen, an LCD screen, a CRT monitor, such as a CTX PR705F from CTX international Inc., or a 3D console projection table such as the TAN HOLOBENCH™ from TAN Projektionstechnologie GmbH & Co. An integrated input device 40 and visualization device 30 combining an LCD screen and a suitable pressure-sensitive ultra pen like PL500 from WACOM can be used as a combined alternative for the usage of a separate input device 40 and visualization device 30. Output device 70 is operative in the forwarding of an integrated video image stream or a standard video stream, such as NTSC to targets external to system 12. Output device 70 can be a modem designed to transmit the integrated video stream to a transmission center in order to distribute the video image, via land-based cables, or through satellites communication networks to a plurality of viewers. Output device 70 can also be a network card, RF Antenna, other antennas, Satellite communication devices such as satellite modem and satellite. Output device 70 can also be a locally disposed video tape recorder provided in order to store temporarily or permanently a copy of the integrated video image stream for optional replay, re-distribution, or long-term storage. Output device 70 can be a locally or remotely disposed display screen utilized for various purposes.

In the preferred embodiment of the present invention, system 12 is utilized as the environment in which the proposed method and apparatus is operating. Input devices 10 such as video cameras capture a plurality of video streams and send the streams to computing device 80 such as a computer processor device. Such video streams can be stored for later used in memory device (not shown) of computing device 80. By means of appropriate software routines, or hardware devices incorporated within device 80 the plurality of the video streams or stored video images are encoded into digital format and combined into an integrated Entire-View image of the action scene to be sent for display on visualization device 30 such as a display screen. The user 50 of system 12 interacts with the system via input device 40 and visualization device 30. User 50 visually perceives the Entire-View image displayed on visualization device 30. User 50 manipulates the input device 40 in order to effect the selection of a viewpoint and an angle from which to view the action-space. The selection is indicated by a visual Selection-Indicator that is manipulable across or in relation to the Entire-View image. Various selection indicators can be used. For example in a three-dimensional Entire-view image an arrow time of Selection-Indicator can be used. Appropriate software routines or hardware devices included in computing device 80 are functional in combining an integrated Entire-View image as well as the synthesis of the Specified-View according to the indication of the VPAS. The video images are processed such that an integrated, composite, image is created. The image is sent to the user interface on the visualization device 30, and optionally to one or more predefined output devices 70. Therefore the composite video stream is created following the manipulation of the user 50 of input device 40. In the present invention image sources can also include a broadcast transmission, computer files sent over a network and the like.

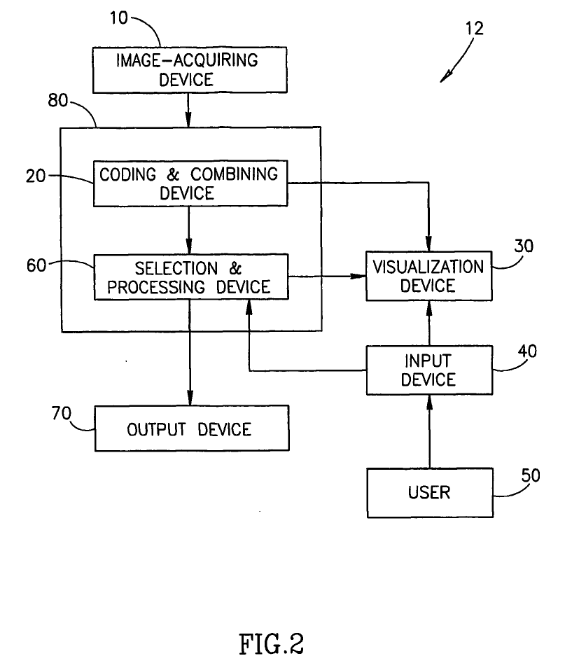

FIG. 2 is a block diagram illustrating the functional components of the system 12 according to the preferred embodiment of the present invention. System 12 comprises image-acquiring device 10, computing device 80, input device 40, visualization device 30, and output device 70. Computing device 80 is a hardware platform comprising a central processing unit (CPU), and a storage device (not shown). Device 80 includes coding and combining device 20, and selection and processing device 60. Coding and combining device 20 is a software routine or a programmable application-specific integrated circuit with suitable processing instructions embedded therein or another hardware device or a combination thereof Coding and combining device 20 is operative in the transformation of visual information captured and sent by image-acquiring device 10 having analog or digital format to a digitally encoded signals carrying the same information. Device 20 is also operative in connecting the frames within the distinct visual streams into a combined Entire-View frame and Specified-View frame dynamically displayed on visualization device 30. Said combination can be alternatively realized via visualization device 30. Image-acquiring device 10 is a video image acquisition apparatus such as a video camera. Device 10 captures dynamic images, encodes the images into visual information carried on an analog or digital waveform. The encoded visual information is sent from device 10 to computing device 80. The information is converted from analog or digital format to digital format and combined by the coding and combining device 20. The coded and combined data is displayed on visualization device 30 and simultaneously sent to selection and processing device 60. A user 50 such as a TV studio director, a conference video coordinator, a home user or the like, visually perceives visualization device 30, and by utilizing input device 40 submits suitable requests regarding the selection and the processing of a viewpoint and angle to selection and processing device 60. Selection and processing device 60 is a software routine or a programmable application-specific integrated circuit with suitable processing instructions embedded therein or another hardware device or a combination thereof Selection and processing device 60 within computing device 80 selects and processes the viewpoint and angle selected by user 50 through input device 40. As a result of the operation the selected and processed video streams are sent to visualization device 30, and optionally to output device 70. Output device 70 can be a modem or other type of communication device for distant location data transfer, a video cassette recorder or other external means of data storage, a TV screen or other means for local image display of the selected and processed data. In the operational flow chart of the general data flow described herein, the functional description of the system components described above is now described from a different point of view, namely, data flow view. Coding and combining process and selection and processing process are interconnected in the disclosed system. A data flow view differs from a component view but it should be apparent to the persons skilled in the art that both describe the same system from two different points of view for the purpose of a full and complete disclosure.

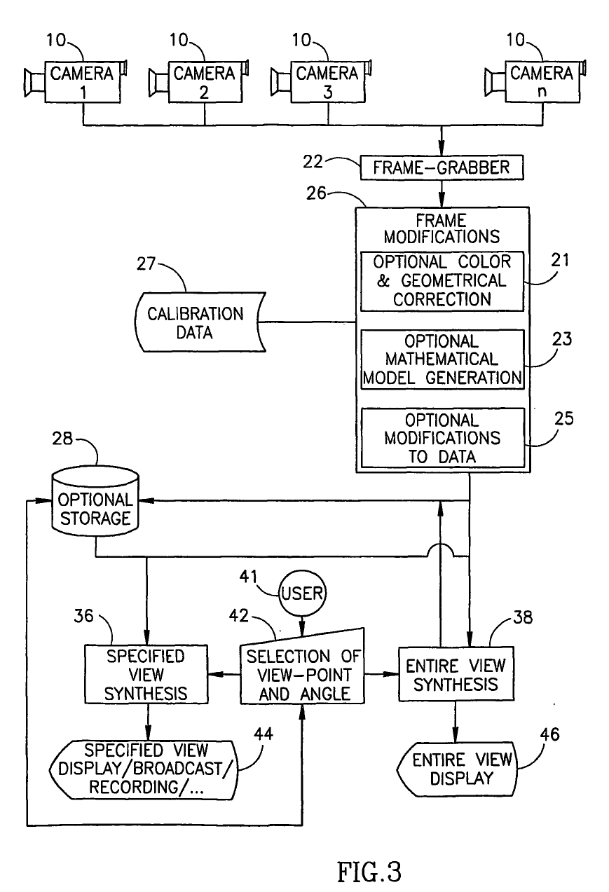

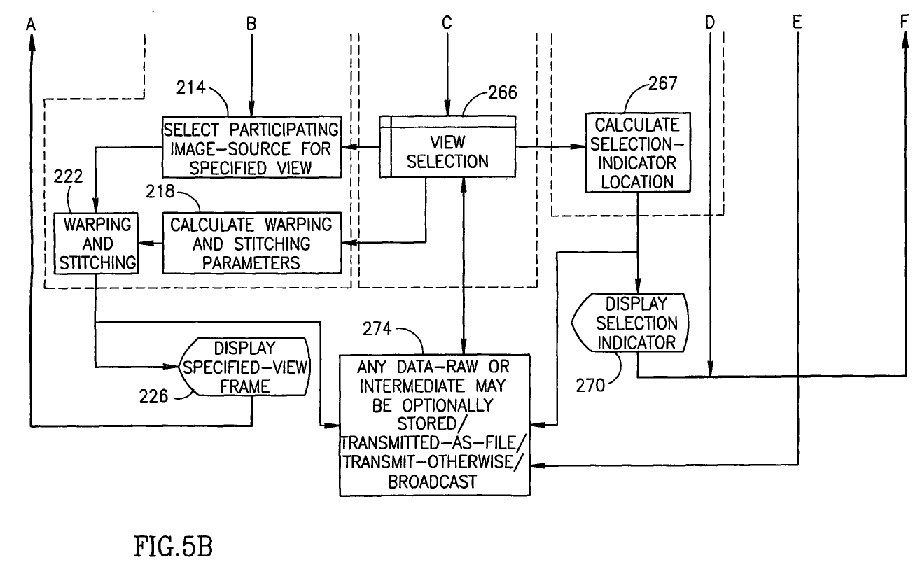

Operational flow chart of the general data flow is now described in FIG. 3, in which images acquired by imaging-acquiring device 10 are transferred via suitable communication interface devices such as coaxial cables to frame grabber 22. Processing performed by frame grabber 22 can include analogue to digital conversion, format conversion, marking for retrieval and the like. Said processing can be realized individually for each camera 10 or alternatively can be realized for a group of cameras. Frame grabber 22 can be DVnowAV from Dazzle Europe GmbH and the like. Such device is typically placed within computing device 80 of FIG. 2. Images obtained by cameras 10, converted and formatted by frame grabber 22 are now processed by device 80 of FIG. 2 as seen in step 26. In frame modification 26, video images are optionally color and geometrical corrected 21 using information obtained from one or a plurality of image sources. Color modifications include gain correction, offset correction, color adaptation and comparison to other images and the like. Geometrical calibration involves correction of zoom, tilt, and lens distortions. Other frame modifications can include mathematical model generation 23, which produces a mathematical model of the scene by analyzing image information. In addition, optional modifications to data 25 can be performed, and involve color changing, addition of digital data to images and the like. Frame modification 26, typically are updated by calibration data 27 that holds a correction formula based on data from frame grabber 22, frame modification process 26 itself as well as from data obtained from images stored in optional storage device 28 as well as other user defined calibration data. Data flow into calibration data 27 is not illustrated in FIG. 3 for simplicity purpose. Frame modification 26 can be realized by software routines, hardware devices, or a combination thereof. For example, the frame-modification 26 can be implemented using a graphics board such as a Synergy™ III from ELSA. Frame modification 26 can also be realized by any software performing the same function. Before or after frame modifications illustrated in step 26, video images from each camera 10 are optionally stored in storage device 28. Storage device 28 can be a Read Only Memory (ROM) device such as EPROM or FLASH from Intel, Random Access Memory (RAM) device or an auxiliary storage device such as magnetic or optical disk. Streaming video images from frame modification process 26 or Video images obtained from storage device 28 as well as from images sent by any communications device to system 12 of FIG. 1 are now synthesized in steps 36 and 38 by computing device 80. Such images can also be received as file over a computer network and the like. Synthesis of images can comprise of selection, processing and combining of video images. In other embodiments, Synthesis can involve rendering a three-dimensional model from the specified viewpoint and angle. Synthesis can be performed while system is on-line receiving images from cameras 10 or off-line receiving images from storage device 28. Off-line synthesis can be performed before the user activates and uses the system. Such synthesis can be of the Specified-View synthesis type, or the Entire-View synthesis type as seen in steps 36 and 38 respectively. In the Specified-View synthesis process, seen in step 36, distinct video images obtained after frame modifications 26 or from storage device 28 are processed and combined either directly, or using a three-dimensional model generated from the distinct video images or a three-dimensional model already kept in storage device 28. Pursuant processing and combination, images are sent for display on visualization device 30, or sent to output devices 70 of FIG. 1 for transmission, broadcasting, recording and the like as seen in step 44. Such processing and combination is further described in detail in FIG. 5. Entire-View synthesis can be constructed from video images obtained after frame modifications 26 or from storage device 28 either directly, or using a three-dimensional model generated from the distinct video images or a three-dimensional model already kept in storage device 28. Images are then processed and combined to produce one large image incorporating the Entire-Views of two or more cameras 10, as seen in step 38. Entire-View images can then be sent for storage 28, as well as sent for display as seen in step 46. Entire-View synthesis processing and combination is further detailed in FIG. 5. User 41, using pointing device 40 of FIG. 1 performs selection of viewpoint and angle coordinates, within Entire-View synthesis field as seen in step 42. Such coordinates are then transferred to Entire-View synthesis process where they are used for View-point and Angle Selector (VPAS) location definition, realization and display. Such process is performed in parallel with Entire-View synthesis and display in steps 38 and 46. Selection of viewpoint and angle coordinates are also sent and used for the performance of Specified-View synthesis as seen in step 36. Viewpoint and angle coordinates can also be sent for storage on storage device 28 for later use. Such use can include VPAS display in replay mode, Specified-View generation in replay mode and the like. Selection of viewpoint and angle is further disclosed in FIG. 5.

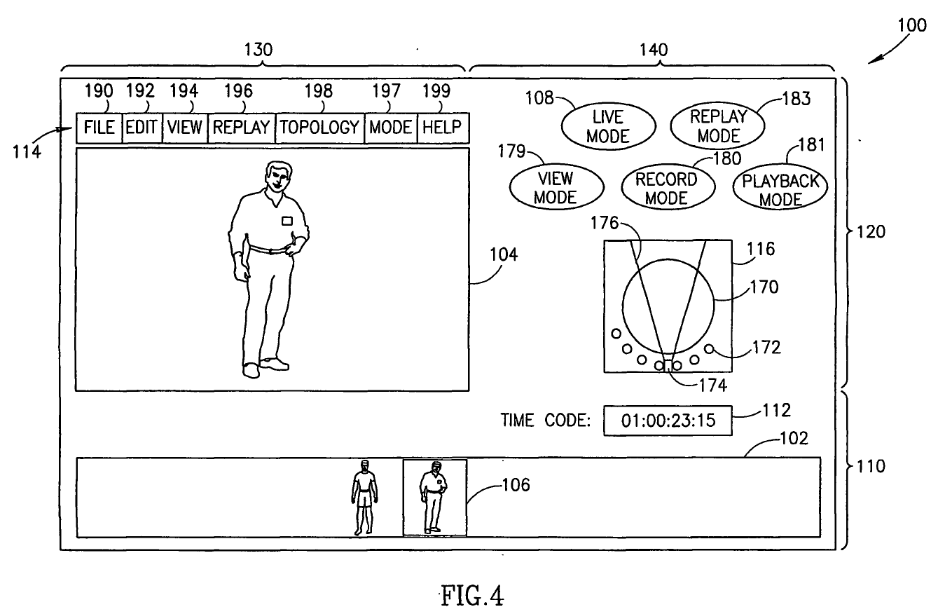

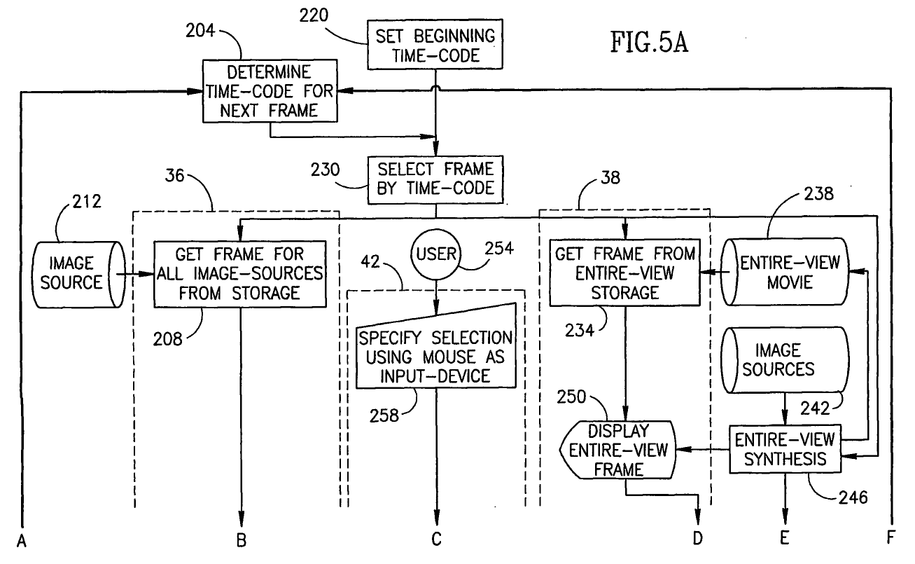

FIG. 4 illustrates an exemplary main window for the application interface. The application interface window is presented to the user 50 of FIG. 2 following a request made by the user 50 of FIG. 2 to load and activate the user interface. In the preferred embodiment of the present invention, the activation of the interface is effected by pointing the pointing device 40 of FIG. 1 to a predetermined visual symbol such as an icon displayed on the visualization device and “clicking” or suitably manipulating the pointer device 40 button. FIG. 4 is a graphical example of a typical main window 100. Window 100 is displayed to the user 50 of FIG. 2 on visualization device 30 of FIG. 1. On the lower portion 110 of the main window 100 above and to the right of wide window 102 a sub-window 112 is located. Sub-window 112 is operative in displaying a time counter referred to as the time-code 112. The time-code 112 can indicate a user predetermined time or any other time code or number. The predetermined time can be the hour of the day. The time-code 112 can also show the elapsed period of an event, the elapsed period of a broadcast, the frame number and corresponding time in movie, and the like. Images derived from visual information captured at the same time, but possibly in different locations or directions, typically have the same time-code, and images derived from visual information captured at different times typically have different time-codes. Typically, the time-code is an ascending counter of movie-frames. The lower portion 110 of main window 100 contains a video image frame 102 referred to as the Entire-View 102. The Entire-View can include a plurality of video images. It can also be represented as a three-dimensional image or any other image showing a filed of view. The Entire-View 102 is a sub-window containing the either multiple video images obtained by the plurality of image-acquiring device 10 of FIG. 1 after processing, or stored multiple video images after processing. Such processing is described above in FIG. 3 and detailed further below in FIG. 5. In the preferred embodiment of the present invention, the multiple images are processed and displayed in a sequential order on an elongated rectangular frame. Such processing is described in FIG. 3 and 5. In other preferred embodiments the Entire-View 102 can be configured into other shapes, such as a square, a cone or any other geometrical form typically designed to fit the combined field of view of the image-acquiring device 10 of FIG. 1. Entire-View can also be a 3-Dimensional image displayed on a suitable display, such as TAN HOLOBENCH™ from TAN Projektionstechnologie GmbH & Co. On the upper 120 left hand side 130 of the main window 100 a Specified-View frame 104 sub-window is shown. Frame 104 displays a portion of the Entire-View 102 that was selected by the user 50 of FIG. 1 as seen in step 42 of FIG. 3. In one preferred embodiment of the present invention, Entire-View 102 can show a distorted action-scene, and Specified-View frame 104 can show an undistorted view of the selected view-point-and-angle. The selected portion of frame 102 represents a visual segment of the action-space, which is represented by the Entire-View 102. The selected frame appearing in window 104 can be sent for broadcast, or can be manipulated prior to the transmission as desired as seen in step 44 of FIG. 3. The displayed segment of Entire-View 102 in Specified-View frame 104 corresponds to that limited part of the video images displayed in Entire-View 102 which is bounded by a graphical shape such as but not limited to a square, or a cone, and referred to as a VPAS 106. VPAS 106 functions as a “virtual camera” indicator, where the action space observed by the “virtual camera” is a part of Entire-View 102, and the video image corresponding to the “virtual camera” is displayed in Specified-View frame 104. VPAS 106 is a two-dimensional graphical shape. VPAS 106 can be given also a three-dimensional format by adding a depth element to the height and width characterizing the frame in the preferred embodiment. Such a three-dimensional shape can be a cone such that the vertex represents the “virtual camera”, the cone envelope represents the borders of the field of view of the “virtual camera” and the base represents the background of the image obtained. VPAS 106 is typically smaller in size compared to Entire-View 102. Therefore, indicator 106 can overlap with various segments of the Entire-View 102. VPAS 106 is typically manipulated such that a movement of the frame 106 is affected along Entire-View 102. This movement is accomplished via the input device 40 of FIG. 1, which can also include control means such as a human touch or a human-manipulated instrument touch on a touch sensitive screen, voice commands. This movement can also be effected, by automatic means such as with automatic tracking of an object within the Entire-View 102 and the like. The video images within the Specified-View frame 104 are continuously displayed along a time-code and correspond to the respective video images enclosed by VPAS 106 on Entire-View 102. Images displayed in Specified-View frame 104 can optionally be obtained from one particular image acquisition device 10 of FIG. 3 as well as said images stored in storage device 28 of FIG. 3. Specified-View images and Entire-View movie can also be displayed in Specified-View frame 104 and wide frame 102 in slow motion as well as in fast motion. Images displayed in frames 104 and 102 are typically displayed in a certain time interval such that continuous motion is perceived. It is however contemplated that such images can be frozen at any point in time and can be also fed at a slower rate, with a longer time interval between images such that slow motion or fragmented motion is perceived. A special option of such system is to display in Specified-View frame 104 two images at the same time-code obtained from two different viewpoints observing the same object within action space displayed in Entire-View 102, in a way that the right-hand image is directed to the right eye of the viewer and the left-hand image is directed to the left eye of the viewer. Such stereoscopic display creates a sense of depth, thus an action space can be viewed in three-dimensional form within Specified-View frame 104. Such stereoscopic data can also be transmitted or recorded by output device 70 of FIG. 2. On the upper 120 right-hand side 140 of main window 100 several graphical representation of operation mode indicators are located. The mode indicators represent a variety of operation modes such as but not limited to view mode 179, record mode 180, playback mode 181, live mode 108, replay mode 183, and the like. The operation mode indicators 108 typically change color, size, and the like, when the specific mode is selected to indicate to the user 50 of FIG. 1 the operating mode of the apparatus. On the upper 120 left-hand side 130 of main window 100 a set of drop-down main menu items 114 are shown. The drop-down main menu items 114 contain diverse menu items (not shown) representing appropriate computer-readable commands for the suitable manipulation of the user interface. The main menu items 114 are logically divided into File main menu item 190, Edit main menu item 192, View main menu item 194, Replay main menu item 196, topology main menu item 198, Mode main menu item 197, and Help main menu item 199. A topology frame 116 displayed in a sub-window is shown in the upper portion 120 of the right hand side 140 below mode indicators of main window 100. Frame 116 illustrates graphically the physical location of the image-acquiring device 10 of FIG. 1 within and around the action space observed. In addition to the indication regarding the locations of the image-acquiring devices 10, the postulated field of view of the VPAS 106 as sensed from its position on the wide frame 102 is indicated visually. The exemplary topology frame 116 shown on the discussed drawing is formed to represent a bird-eye's view of a circular track within a sporting stadium. The track is indicated by the display of circle 170, the specific cameras are symbolized by smaller circles 172, and the VPAS is symbolized by a rectangle 174 with an open triangle 176 designating the selection indicator 106 field of view. Note should be taken that the above configuration is only exemplary, as any other possible camera configuration suitable for a particular observed action taking place in a specific action space can be used. Other practical camera configurations could include, for example, a partially semi-elevated side view of a basketball field having multitude of cameras observing from the side of the court as well as from the ceiling above the court, sidelines of the court and any other location observing the action space. Topology frame 116 can substantially assist the user 50 of FIG. 1 in identifying the projected viewpoint displayed in Specified-View frame 104. Frame 116 can also assist the director to make important directorial decision on-the-fly such as rapidly deciding which point of view is the optimal angle for capturing an action at a certain point in time. The user interface can use information obtained from image acquiring devices 10 regarding the action space such that different points of view observing the action space can be assembled and displayed. It would be apparent to one with an ordinary skill in the art that the above description of the present invention is provided for the purposes of ready understanding merely. For example, the Specified-View frame 104 can be divided or multiplied to host a number of video images displayed on the main window 100 simultaneously. A different configuration could include an additional sub-window (not shown) located between Specified-View frame 104 and operation mode indicators 108. The additional sub-window can display playback video images and can be designated as a preview frame. Additional sub-windows could be added which can be used for editing, selecting and manipulating video images. Additional sub-windows could display additional VPAS 106, such that multiple Specified-Views can be selected at the same time-code. In another preferred embodiment of the present invention, the Specified-View frame 104 sub-window could be made re-sizable and re-locatable. The frame 104 could be resized to a larger size, or could be re-located in order to occupy a more central location in main window 100. In another preferred embodiment of the present invention, Entire-View 102 could overlie Specified-View frame 104, in such a manner that a fragment of the video images displayed in Specified-View frame 104 will be semitransparent, while Entire-View 102 video images are displayed in the same overlying location. A wire frame configuration can also be used, where only descriptive lines comprising overlying displayed images are shown. Such a configuration allows the user to concentrate on one area of main window 100 at all times, reducing fatigue and increasing accuracy and work efficiency. Additional embodiment of the preferred embodiment can include VPAS 106 and Entire-View 102, in which Entire-View 102 can be displaced about a static VPAS 106. It would be apparent to the person skilled in the art that many other embodiments of main window for the application interface can be realized within the scope of the present invention.

FIG. 5 is an exemplary operational flowchart of the user interface illustrating Entire-View synthesis, Specified-View synthesis and selection of viewpoint and angle processes. Selection of viewpoint and angle is a user-controlled process in which the user selects the coordinates of a specific location within the Entire-View. These coordinates are graphically represented on the Entire-View as Selection-Indicator display. Said coordinates are used for Specified-View synthesis process, and can be saved, retrieved and used for off-line manipulation and the like. Synthesis involves manipulation of video images as described herein for display, and broadcast of video images. In this example, synthesis of video images involves pasting of two or more images. Such pasting involves preliminary manipulation of images such as rotation, stretching, distortion corrections such as tilt and zoom corrections, as well as color corrections and the like. Such process is termed herein warping. Following warping, images are combined by processes such as cut and paste, Alfa blending, Pattern-Selective Color Image Fusion as well as similar methods for synthesis manipulation of images. In this example of Specified-View synthesis, a maximum of two images are synthesized to produce a single image. Such synthesis achieves an enhanced image size and quality, in a two dimensional image. The Entire-View synthesis, however, is performed for three or more images, and is displayed in low quality in small image format. Entire-View images are multi image constructs that can be displayed in two or three-dimensional display such as on a sphere or cylinder display units and the like.

The flow chart described in FIG. 5 comprises three main processes occurring in the user interface in harmony, and corresponding to like steps in FIG. 3, namely, Specified-View synthesis 36, selection of viewpoint and angle 42 as well as Entire-View synthesis 38. At step 220, the beginning time-code is set, from which to start displaying the Entire-View and the Specified-View. User 254 can select the beginning time-code by manipulating appropriate input device 40 of FIG. 1, such as keyboard push-button, clicking a mouse pointer device, using voice command and the like. The beginning time-code can also be set automatically, for example, using “bookmarks”, using object searching, etc. Running the different views of the video, and advancing the time-code counter can be terminated when video images are no longer available for synthesis or when user 254 commands such termination by manipulating appropriate input device 40 of FIG. 1. A time-code interval is defined as the time elapsing between each two consecutive time-codes. “Synthesis Interval” is defined as the time necessary for Computing Device 80 to synthesize and display an Entire-View image and a Specified-View image. Consecutive images must be synthesized and displayed at a reasonable pace, to allow a user to observe sequential video images at the correct speed. In different embodiments, the Synthesis Interval can vary from one time-code to the next due to differences in the complexity of the images. The Synthesis Interval is determined by Computing Device 80 of FIG. 1 for each frame sequence, as seen in step 204. If Synthesis Interval is smaller than or equal to the time-code interval, Computing Device 80 of FIG. 1 retrieves the following image in line. If, however, Synthesis Interval is larger than the time-code interval, Computing Device 80 of FIG. 1 will skip images in the sequence, and retrieve the image with the proper time-code to account for the delay caused by the long Synthesis Interval. Thus images in the sequence can be skipped, to generate a smooth viewing experience. Frame selection by time-code interval and Synthesis Interval is illustrated in step 204. Time-code Interval vs. Synthesis Interval constraints is related to hardware performance. The use of the proposed invention in junction with a fast processor (For example, a dual-CPU PC system, with 2 1 GHz CPUs, 1 Gbyte RAM, and a 133 MHz motherboard) provides a small Synthesis Interval, thus eliminating the need to skip images. In operation, user 254 selects the beginning of a session, time-code is set in step 220. The frame corresponding to current time-code is now selected by computing device 80 of FIG. 1. Selected frame is now processed in the Specified-View synthesis 36 and Entire-View synthesis 38 described here forth. After display of the selected frame in steps 226 and 250, computing device 80 of FIG. 1 determines the time-code for the next frame as seen in step 204. If Synthesis Interval is smaller than or equal to the time-code interval determined at step 204, Computing Device 80 of FIG. 1 retrieves the following image in line. If, however, Synthesis Interval is larger than the time-code interval, Computing Device 80 of FIG. 1 will skip images in the sequence, and retrieve the image with the proper time-code to account for the delay caused by the long Synthesis Interval. Referring now to the specified synthesis 36, where in step 208, images corresponding to time-code are retrieved from image sources 212, such as image acquiring devices 10 of FIG. 1, storage device 28 of FIG. 3, image files from a computer network, images from broadcasts obtained by the system and the like, on-line or off-line by CPU 80 of FIG. 1. All the images with the selected time-code are retrieved. In step 214 CPU 80 of FIG. 1 select the participating image sources to be used in warping according to data received from selection of view-point and angle process 42 selected by the user 254. An alternative flow of data (not shown) such that Step 214 and 208 can occur together in such a manner that only images selected at step 214 will be retrieved from image source 212 at step 208. CPU 80 of FIG. 1, determines warping and stitching parameters according to information received from selection and view-point and angle process 42. In step 222 warping and stitching of image sources obtained at step 214 according to data obtained at step 218 is performed. In this step the image to be displayed as the Specified-View is constructed. If the image selected by the user in the view-point and angle selection process 42 is a single image then that image is the image to be displayed in the specified view. If more than one image is selected within the view-point and angle selection process 42 then the relevant portions of the images to be shown in the Specified-View are cut, warped and stitched together so as to create a single image displayed in the Specified-View. Image created in step 222 is then displayed in Specified-View frame 104 of FIG. 4. Images created in step 222 can also be sent for storage, transmission as files, broadcasted and the like, as seen in step 274. Specified-View synthesis is then restarted in step 204 where time-code for next frame is compared with time elapsed for synthesis of current image. In Entire-View synthesis 38, Entire-View movie is constructed from a series of at least three images as described here forth in step 246. Entire-View can be generated on-line by synthesis of Entire-View at step 246. In step 246 image sources 242 are obtained from frame modification process 26 of FIG. 3 and warped and stitched. The process of warping and stitching is described above in connection with the Specified-View synthesis. Entire-View is then either displayed in step 250 or stored as entire-view movie seen in step 238. Entire-view can also be sent for transmission and broadcast as described in step 274. Entire-View synthesis also involves the calculation of VPAS 106 of FIG. 4 via data obtained from selection of viewpoint and angle process 42 as seen in step 266. VPAS location calculated in step 267 can also be sent for storage, transmission as files, broadcasted and the like, as seen in step 274. In other embodiments, step 267 calculates the shape of the Selection-Indicator, as well as its location. Selection-Indicator is then displayed on Entire-View 102 of window 100 of FIG. 4. Entire-View synthesis is then restarted in step 204 where time-code for next frame is compared with time elapsed for synthesis of current image. Entire-View can alternatively be generated off-line and stored as Entire-View movie 238 in storage device 28 of FIG. 3. Then, Entire-View movie 238 can be retrieved by CPU 80 of FIG. 1 as seen in step 234 and displayed in Entire-View 102 of FIG. 4 of visualization device 30 of FIG. 1 as seen in step 250. Referring now to selection of viewpoint and angle process 42 where user 254 manipulates input device 40 of FIG. 1 to specify selection of viewpoint and angle coordinates as seen in step 258. The Selection-Indicator 106 of FIG. 1, which is a graphical representation of the current VPAS coordinates, is displayed on the Entire-View 102 of FIG. 4 to aid the user 254 in selecting the correct coordinates. In step 266 CPU 80 of FIG. 1 determines spatial coordinates within Entire-View 102 of FIG. 1 and then uses the coordinates for Specified or Entire-View synthesis as well as for storage, transmission as files, broadcasting and the like as seen in step 274.

It should be understood that FIG. 5 is a flow chart diagram illustrating the basic elements of the operational routines of the user interface described above and is not intended to illustrate a specific operational routine for the proposed user interface. The invention being thus described, it would be apparent that the same method can be varied in many ways. Such variations are not to be regarded as a departure from the spirit and scope of the invention, and all such modifications as would be apparent to one skilled in the art are intended to be included within the scope of the following claims. Any other configuration based on the same underlying idea can be implemented within the scope of the appended claims.

I/we claim:

1. Within a computerized system having at least one display, at least one central processing unit, at least one memory device and at least one input device, a plurality of images received from an image-acquiring device an apparatus for controlling and processing of video images, the apparatus comprising:
A frame grabber for processing image frames received from the image-acquiring device;
An Entire-View synthesis device for creating an Entire-View image from the images received;
A Specified-View synthesis device for preparing and displaying a selected view from the Entire-View image;
A selection of view-point-and-angle device for receiving user input and identifying a specified view selected by the user.

2. The apparatus of claim 1 further comprising a frame modification module for image color and geometrical correction.

3. The apparatus of claim 1 further comprising a frame modification module for mathematical model generation.

4. The apparatus of claim 1 further comprising a frame modification module for image data modification.

5. The apparatus of claim 1 further comprising a storage device for storing images processed by the frame grabber and the frame modification devices.

6. Within a computerized system having at least one display, at least one central processing unit, at least one memory device and at least one input device an apparatus for controlling and processing of video images the apparatus comprising a coding and combining device for transforming information sent by an image capturing device and combining the information sent into a single frame dynamically displayed on the display; and a selection and processing device for selecting and processing the viewpoint and angle selected by a user of the apparatus.

7. Within a computerized system having at least one display, at least one central processing unit and at least one memory device a user interface for controlling and processing of video images the user interface displayed within a graphical window and operating in conjunction with a video display and at least one input device, the user interface comprising:
A first sub-window displaying an Entire-View image;
A second sub-window displaying a Specified-View image representing an image selected by the user from the Entire-View image to be displayed as the Specified-View image.

8. The apparatus of claim 7 further comprising a third sub-window displaying a time counter indicating a predetermined time;

9. The apparatus of claim 7 wherein the Entire-View comprises a plurality of images received from a plurality of sources and displayed to the video display.

10. The apparatus of claim 7 further comprising a view-point-and-angle selection device for selecting the image part selected on the Entire-View and displayed as the Specified-View image.

11. The apparatus of claim 7 further comprising a view-point-and-angle Selection-Indicator device for identifying the image part selected on the Entire-View and displayed as the Specified-View image.

12. The apparatus of claim 7 wherein the view-point-and-angle selection device is moveable within the Entire-View image in response to user input.

13. The apparatus of claim 7 wherein the Specified-View displays at least two images at a time, the right hand image is directed towards the right eye and the left hand image is directed towards the left eye.

14. The apparatus of claim 7 further comprising operation mode indicators for indicating the operation mode of the apparatus.

15. The apparatus of claim 7 further comprising a topology frame for displaying the physical location of at least one image-acquiring device.

16. The apparatus of claim 7 further comprising at least two view-point-and-angle selection indicators.

17. The apparatus of claim 7 further comprising a topology frame for displaying the physical location of at least one image-acquiring device associated with the image-acquiring device information displayed in the second sub-window displaying an specified-view image.

18. The apparatus of claim 17 further comprising a virtual camera indicator representsing the current viewpoint and angle offered for transmission.

19. Within a computerized system having at least one display, at least one central processing unit and at least one memory device a method for controlling and processing of video images within a user interface, the method comprising determining a time code interval; and processing the image corresponding to the time code interval.

20. The method of claim 19 further comprising the step of setting a time code from which image is displayed.

21. The method of claim 19 wherein the step of processing further comprises:
retrieve frame for all image sources from an image source for the time code interval associates image selected;
select participating image sources associated with the view point and angle selector selected by the user;
determine warping and stitching parameters;
prepare image to be displayed in selection indicator view;
display image in the selection indicator.

22. The method of claim 19 further comprising the step of storing the image.

23. The method of claim 19 wherein the step of processing further comprises:
constructing Entire-View movie from at least two images;
display Entire-View image;
determine Entire-View and angle selector position;
display Entire-View and angle selector on display.

24. The method of claim 23 wherein the step of constructing further comprises obtaining the at least two images from a frame modification module, and warping and stitching the at least two images to create an entire view image.

25. The method of claim 23 further comprising storing of Entire-View image.

26. The method of claim 19 wherein the step of processing further comprises constructing entire Entire-View movie images from at least two images and storing said images for later display.

27. The method of claim 19 wherein the step of processing further comprises constructing Entire-View movie from at least two images and storing said image for later transmission.

28. The method of claim 19 further comprising displaying a view point and angle selector on an Entire-View frame, and determining the Specified-View corresponding to a user movement of the view point and angle selector on an Entire-View frame.
